(19) United States
(12) Patent Application Publication
(10) Pub. No.: US 2004/0184046 A1
(43) Pub. Date: Sep. 23, 2004

(54) Image forming apparatus and image forming method

(75) Inventor: Sadahiro Masuda, Mishima-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/388,494

(22) Filed: Mar. 17, 2003

(51) Int. Cl. G06F 15/00

(52) U.S. Cl. 358/1.5; 358/1.12

(57) ABSTRACT

In black-and-white printing, a system control section rotates a revolver including a plurality of color developing devices, moves each color developing device to a non-development position relative to an image carrying body, and develops a toner image on the image carrying body using a black developing device having a default position set at a development position.

### BACKGROUND OF THE INVENTION

The present invention relates to an image forming apparatus, such as a copying machine, a facsimile or a printer, wherein an electrostatic latent image formed on an image carrying body is developed by a developing device to form an image, and to an image forming method.

There is known a conventional image forming apparatus having two or more developing devices arranged in the vicinity of an image carrying body (photosensitive drum). In this case, one developing device (hereinafter referred to as “developing device A”) is necessarily set at a development position in order to develop a toner image on the image carrying body. The image carrying body and a developing roller of the developing device A are opposed to each other with a predetermined gap. At this time, the other developing device (hereinafter referred to as “developing device B”) is set at a separated position where the developing device B is situated away from the image carrying body and cannot perform developing. When the developing device B performs development, the developing device B is moved by an external power to a development position where development can be performed. The image carrying body and a developing roller of the developing device B are opposed to each other with a predetermined gap, thereby performing developing.

There is also known an apparatus wherein both developing devices A and B are situated away from the image carrying body. Only when both developing devices A and B perform a developing operation, these devices are moved to the development position. The image carrying body and developing rollers of the developing devices are opposed to each other with a predetermined gap, thereby performing a developing operation.

In the prior art, as has been described above, the developing device needs to be moved to the development position each time a toner image is developed on the image carrying body. In this method, the developing device needs to be moved a number of times corresponding to the number of times of developing operations. In this case, if the life of the product, such as a printer or a copying machine, is considered, the number of times of developing operations is several hundred thousand to several millions, and so the developing device needs to be moved as many times. If the developing device is moved hundreds of thousands of times to several millions of times, the image quality would possibly be adversely affected due to wear or degradation of components of the developing device.

In addition, the same number of times of operations are required for the transmission of power for position movement as well as for the components for power transmission. If such components cannot withstand hundreds of thousands of times to several millions of times of use, the components have to be replaced as periodical replacement parts, which is disadvantageous in terms of maintenance cost.

Even where such components can withstand hundreds of thousands of times to several millions of times of use, if the components employed are long-life components, it is necessary to select more expensive components than components with ordinary life.

### BRIEF SUMMARY OF THE INVENTION

An advantage of an aspect of the present invention is to provide an image forming apparatus and an image forming method capable of increasing the life of components of a developing device, thereby preventing them from being replaced as periodic replacement parts.

The present invention may provide an image forming apparatus that has an image carrying body and forms an image, comprising: a black developing device having, as a default position, a position where an electrostatic latent image formed on the image carrying body is developed, and developing the electrostatic latent image formed on the image carrying body; a developing unit that is rotatable and includes a plurality of developing devices which develop electrostatic latent images formed on the image carrying body in a plurality of colors; a first control section that controls rotation of the developing unit, when a black-and-white image is to be formed, thereby moving all the plurality of developing devices of the developing unit to a non-development position; and a second control section that effects a control, when a color image is to be formed, to successively move the plurality of developing devices of the developing unit to a development position relative to the image carrying body and to move the black developing device from the default position to a separated position where development is not performed, during a time period from a beginning to an end of development by the plurality of developing devices.

The present invention may also provide an image forming method for forming an image, with provision of a developing unit that is rotatable and includes a plurality of color developing devices which develop electrostatic latent images formed on an image carrying body, and a black developing device having, as a default position, a position where an electrostatic latent image formed on the image carrying body is developed, and developing the electrostatic latent image formed on the image carrying body, the method comprising: controlling rotation of the developing unit, when a black-and-white image is to be formed, thereby moving all the plurality of color developing devices of the developing unit to a non-development position; and effecting a control, when a color image is to be formed, to successively move the plurality of developing devices of the developing unit to a development position relative to the image carrying body, and to move the black developing device from the default position to a separated position where development is not performed, during a time period from a beginning to an end of development by the plurality of developing devices.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram schematically showing the structure of an image forming apparatus according to the present invention;

FIG. 2 is a view for describing the structure of an image carrying body and developing devices;

FIG. 3 is a view for describing a separated position of a developing device;

FIG. 4 is a flow chart illustrating a developing operation in the case of performing color printing; and

FIG. 5 is a flow chart illustrating a developing operation in the case of performing black-and-white printing.

### DETAILED DESCRIPTION OF THE INVENTION

An embodiment of the present invention will now be described with reference to the accompanying drawings.

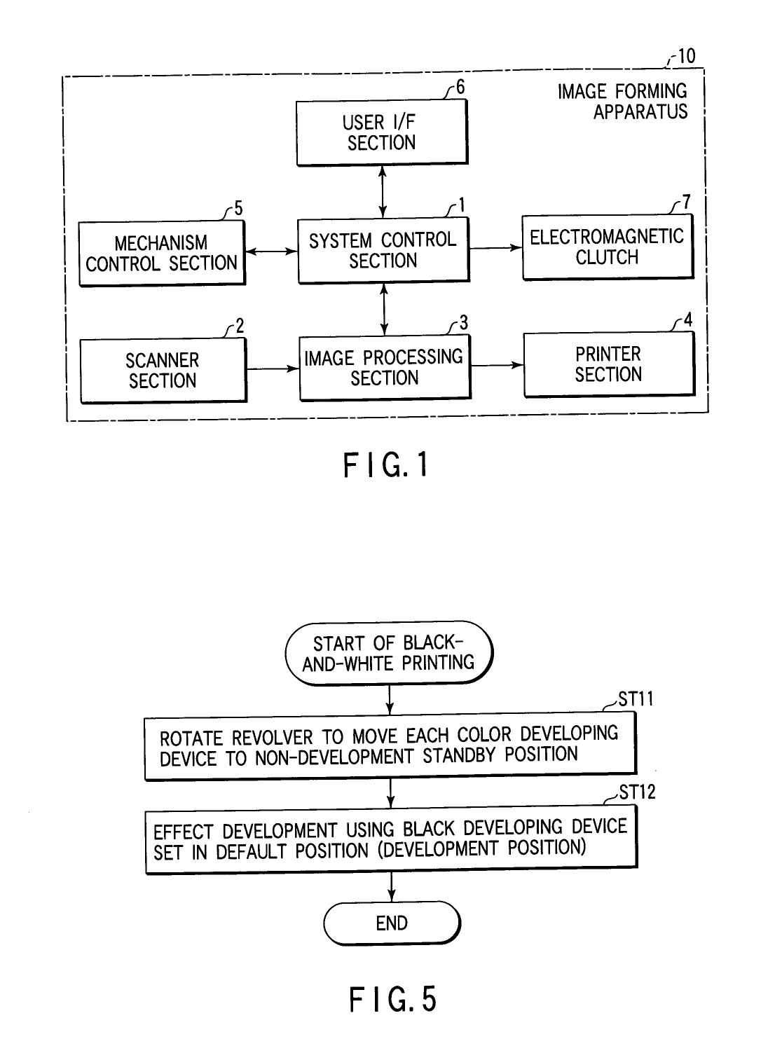

FIG. 1 schematically shows the structure of an image forming apparatus 10 according to the present invention.

Specifically, the image forming apparatus 10 comprises a system control section 1, a scanner section 2, an image processing section 3, a printer section 4, a mechanism control section 5, a user I/F section 6 and an electromagnetic clutch 7.

The system control section 1 controls the entirety of the system.

The scanner section 2 scans an original while illuminating the original with light from a light source, and reads reflective light from the original by means of a color CCD sensor.

The image processing section 3 subjects the image data read by the scanner section 2 to processes such as γ-correction, color conversion, main-scan magnification alteration, image separation, processing, an area process, and a tone correction process.

The printer section 4 forms an image based on the image data output from the image processing section 3.

The mechanism control section 5 controls the mechanisms of the respective units of the present apparatus.

The user I/F section 6 displays screens through which the user inputs operational settings of the present apparatus.

The electromagnetic clutch 7 shifts a default position of a developing device, as will be described later in detail.

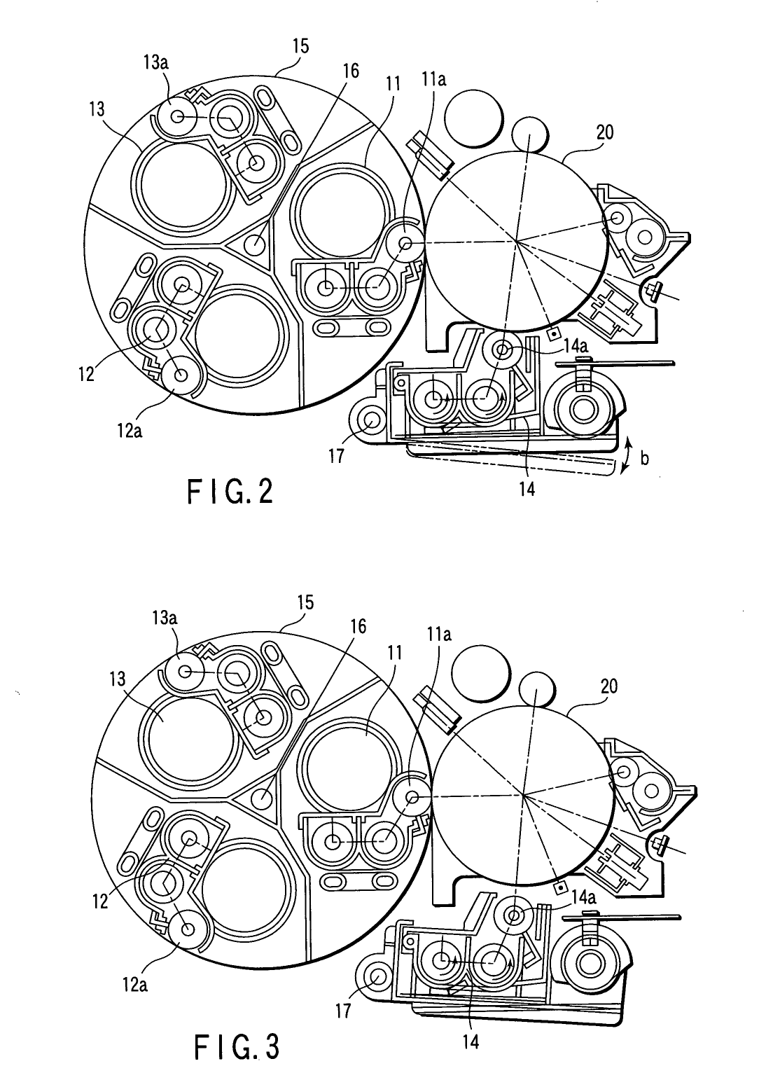

FIG. 2 shows the structures of an image carrying body (photosensitive drum) and developing devices. Specifically, the image forming apparatus 10 includes developing devices 11, 12 and 13 and a developing device 14 arranged around an image carrying body 20.

The developing devices 11, 12 and 13 have developing rollers 11a, 12a and 13a, respectively. The developing devices 11, 12 and 13 are provided on a revolver 15. The developing devices 11, 12 and 13 are disposed about a rotational shaft 16 of the revolver 15, thus constituting a developing unit. The developing devices 11, 12 and 13 contain toners of different colors (e.g. yellow, magenta and cyan). That is, the developing devices 11, 12 and 13 constitute a color developing system of a generally called “revolver type”.

Assume that the developing device 11 contains a yellow toner, the developing device 12 contains a magenta toner, and the developing device 13 contains a cyan toner.

The revolver 15 is rotated by a motor (not shown) that is controlled by the system control section 1.

In this revolver-type developing system, only one development position is defined between each developing device 11, 12, 13 and the image carrying body 20. In other words, any one of the developing devices 11, 12 and 13 is set at the development position relative to the image carrying body. Aside from these developing devices, the image forming apparatus 10 of the present invention includes the developing device 14 which has one development position relative to the image carrying body 20. The developing device 14 has a developing roller 14a and contains a black toner. The developing devices 11, 12 and 13 have the common development position relative to the image carrying body 20. The image forming apparatus 10 has the developing device 14, which is disposed at a development position relative to the image carrying body 20, which is different from the above-mentioned common development position of the developing devices 11, 12 and 13.

The developing device 14 has a default position as an initial set position, which is set at its development position. At this development position, the developing roller 14a is opposed to the image carrying body 20 with a predetermined gap. Thereby, the developing roller 14a can perform development. In addition, the developing device 14 can be shifted to a separated position, that is, a position (non-development position) where the developing roller 14a cannot perform development on the image carrying body 20.

To be more specific, the developing device 14 is moved from the default position (development position) to the separated position (non-development position) (in a direction b) about a rotational shaft 17 by the aforementioned electromagnetic clutch 7. Thereby, the developing roller 14a of developing device 14 is shifted from the default position shown in FIG. 2, where a predetermined gap is provided between the developing roller 14a and the image carrying body 20, to the separated position shown in FIG. 3 where the developing roller 14a is moved away from the image carrying body 20. Inversely, the developing roller 14a is also shifted from the separated position (non-development position) to the default position (development position) by the electromagnetic clutch 7 (in the direction b).

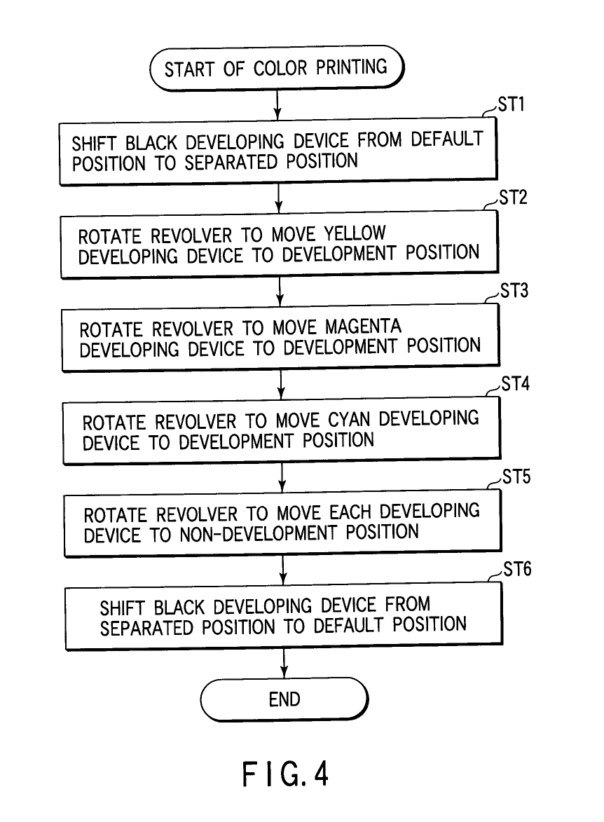

The developing operation for color printing in the image forming apparatus 10 with the above-described structure will now be described with reference to a flow chart of FIG. 4.

In the case of color printing, the system control section 1 of the image forming apparatus 10 shifts the black developing device 14 from the default position to the separated position by means of the electromagnetic clutch 7, thereby moving the developing roller 14a away from the image carrying body 20 so as to prohibit development (ST1).

Then, the system control section 1 rotates the revolver 15 and moves the yellow developing device 11 to the development position (ST2). The development position, in this context, is a position where the developing roller 11a of the yellow developing device 11 is opposed to the image carrying body 20 with a predetermined gap. The system control section 1 develops a toner image (yellow) on the image carrying body 20 by means of the developing roller 11a.

Subsequently, the system control section 1 rotates the revolver 15 and moves the magenta developing device 12 to the development position (ST3). The development position, in this context, is a position where the developing roller 12a of the magenta developing device 12 is opposed to the image carrying body 20 with a predetermined gap. The system control section 1 develops a toner image (magenta) on the image carrying body 20 by means of the developing roller 12a.

Further, the system control section 1 rotates the revolver 15 and moves the cyan developing device 13 to the development position (ST4). The development position, in this context, is a position where the developing roller 13a of the cyan developing device 13 is opposed to the image carrying body 20 with a predetermined gap. The system control section 1 develops a toner image (cyan) on the image carrying body 20 by means of the developing roller 13a.

Thereafter, the system control section 1 rotates the revolver 15 and makes it stand by at a non-development position (ST5). The non-development position, in this context, is a position where none of the developing rollers 11a, 12a and 13a is opposed to the image carrying body 20 with a predetermined gap.

Finally, the system control section 1 shifts the black developing device 14 to the default position (development position) by means of the electromagnetic clutch 7 (ST6), and setting the developing roller 14a to be opposed to the image carrying body 20 with a predetermined gap. Thus, the system control section 1 develops a toner image (black) on the image carrying body 20 by means of the developing roller 14a.

As has been described above, the developing device 14 is moved twice by the electromagnetic clutch 7 for the position shift relative to the image carrying body 20. That is, in the first movement, the developing device 14 is moved from the default position (development position) to the separated position, and in the second movement it is moved from the separated position to the default position (development position).

The revolver 15 is rotated four times.

The developing operation for black-and-white printing in the image forming apparatus 10, which uses only black toner, will now be described with reference to a flow chart of FIG. 5.

In the case of black-and-white printing, the system control section 1 of the image forming apparatus 10 rotates the revolver 15 and makes it stand by at the non-development position where none of the developing devices (11, 12, 13) is opposed to the image carrying body 20 (ST1).

At this time, the black developing device 14 is set in the default position (development position), and the developing roller 14a is opposed to the image carrying body 20 with a predetermined gap. Thus, in this state, the system control section 1 develops a toner image on the image carrying body 20 by means of the black developing roller 14a (ST12).

As has been mentioned above, the default position of the developing device 14 is set at the development position, as shown in FIG. 2. Therefore, the development can be performed without a single moving operation of the developing device 14.

As has been described above, when a component, such as the electromagnetic clutch 7, is used to rotate the revolver 15 or to shift the position of the developing device 14, the developing device may be moved only when necessary.

For example, in a case where printing of black is intermittently performed for five paper sheets using the developing device 14, black-and-white development can be performed simply by rotating the revolver 15 and moving the developing devices 11, 12 and 13 to the non-development position, without moving the developing device 14 at all.

On the other hand, if the developing device is disposed at a position away from the image carrying body, as in the prior art, it is necessary to move the developing device to the development position each time development of an image for each paper sheet is performed, and to move the developing device to the separated position away from the image carrying body each time development is completed. In this case, if black-and-white printing is intermittently performed for five paper sheets, the developing device needs to be moved ten times and also the electromagnetic clutch needs to be driven ten times.

This embodiment of the present invention is configured to reduce the number of times of use of the electromagnetic clutch. Therefore, the number of times of use of the electromagnetic clutch differs tenfold from that in the prior art.

In consideration of the number of times of development in this product, the number of times of use of the electromagnetic clutch can remarkably be reduced.

In the above-described embodiment, the electromagnetic clutch is used. Even in a case where a motor is used as the power source for the position shifting mechanism, both the number of times of operation and the time period of operation can be reduced.

In the above embodiment, the revolver includes three developing devices. Alternatively, the revolver may include four developing devices. For example, four developing devices for yellow, magenta, cyan and black may be used for color printing, and a developing device for black may be used for black-and-white printing.

As has been described above, according to the embodiment of the present invention, the default position (initial set position) of the developing device with the position shift mechanism is set at the development position. Thereby, it is possible to reduce the number of times of use and the time period of use of the power source for position shift of the developing device and the components of the power transmission mechanism.

Therefore, unnecessary use of long-life parts and periodical replacement of parts can be prevented, and the cost of parts and products can be decreased.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus that has an image carrying body and forms an image, comprising:
a black developing device having, as a default position, a position where an electrostatic latent image formed on the image carrying body is developed, and developing the electrostatic latent image formed on the image carrying body;
a developing unit that is rotatable and includes a plurality of developing devices which develop electrostatic latent images formed on the image carrying body in a plurality of colors;
a first control section that controls rotation of the developing unit, when a black-and-white image is to be formed, thereby moving all the plurality of developing devices of the developing unit to a non-development position; and
a second control section that effects a control, when a color image is to be formed, to successively move the plurality of developing devices of the developing unit to a development position relative to the image carrying body and to move the black developing device from the default position to a separated position where development is not performed, during a time period from a beginning to an end of development by the plurality of developing devices.

2. The image forming apparatus according to claim 1, wherein the black developing device has a developing roller and the black developing device in the default position is disposed such that the developing roller of the black developing device is opposed to the image carrying body with a predetermined gap.

3. The image forming apparatus according to claim 1, wherein the plurality of developing devices of the developing unit have developing rollers, respectively, and the developing unit is disposed such that the developing roller of any one of the plurality of developing devices is opposed to the image carrying body with a predetermined gap.

4. The image forming apparatus according to claim 1, wherein the first control section effects a control to perform development using the black developing device remaining in the default position, without effecting the control to move the black developing device.

5. The image forming apparatus according to claim 1, wherein the second control section effects a control to move a developing roller provided in the black developing device to a separated position where the developing roller is so situated away from the image carrying body that development is not performed.

6. An image forming apparatus that has an image carrying body and forms an image, comprising:
a developing unit that is rotatable and includes a plurality of developing devices which develop electrostatic latent images formed on the image carrying body;
a first control section that controls rotation of the developing unit, thereby moving one of the plurality of developing devices or all the plurality of developing devices to a non-development position, relative to the image carrying body;
a developing device having a default position set at a development position relative to the image carrying body, and developing an electrostatic latent image formed on the image carrying body; and
a second control section that effects a control to move the black developing device from the default position to a separated position where development is not performed relative to the image carrying body, or from the separated position to the default position.

7. The image forming apparatus according to claim 6, wherein the developing unit comprises three developing devices containing three color toners of yellow, magenta and cyan, respectively.

8. The image forming apparatus according to claim 6, wherein the developing unit comprises four developing devices containing four color toners of yellow, magenta, cyan and black, respectively.

9. The image forming apparatus according to claim 6, wherein the plurality of developing devices included in the developing unit have developing rollers, respectively.

10. The image forming apparatus according to claim 9, wherein the first control section controls the rotation of the developing unit, setting a position, as a development position, where any one of the developing rollers is opposed to the image carrying body with a predetermined gap, and a position, as a non-development position, where each of the developing rollers is so positioned away from the image carrying body that development is not performed.

11. The image forming apparatus according to claim 6, wherein the first control section effects a control, when a black-and-white image is to be formed, to move all the plurality of developing devices of the developing unit to the non-development position.

12. The image forming apparatus according to claim 6, wherein the first control section effects a control, when a color image is to be formed, to successively move the plurality of developing devices of the developing unit to the development position.

13. The image forming apparatus according to claim 6, wherein the developing device having the default position set at the development position relative to the image carrying body contains a black toner.

14. The image forming apparatus according to claim 6, wherein the second control section effects a control, when a black-and-white is to be formed, to restore the developing device, which has the default position relative to the image carrying body, to the default position only when the developing device is placed in the separated position.

15. The image forming apparatus according to claim 6, wherein the second control section effects a control, when a color image is to be formed, to move the developing device, which is set at the default position relative to the image carrying body, to the separated position when development by the plurality of developing devices of the developing unit begins, and to restore the developing device from the separated position to the default position when the development by the plurality of developing devices of the developing unit ends.

16. An image forming method for forming an image, with provision of a developing unit that is rotatable and includes a plurality of color developing devices which develop electrostatic latent images formed on an image carrying body, and a black developing device having, as a default position, a position where an electrostatic latent image formed on the image carrying body is developed, and developing the electrostatic latent image formed on the image carrying body, the method comprising:
controlling rotation of the developing unit, when a black-and-white image is to be formed, thereby moving all the plurality of color developing devices of the developing unit to a non-development position; and
effecting a control, when a color image is to be formed, to successively move the plurality of developing devices of the developing unit to a development position relative to the image carrying body, and to move the black developing device from the default position to a separated position where development is not performed, during a time period from a beginning to an end of development by the plurality of developing devices.
